(19) United States
(12) Patent Application Publication
(10) Pub. No.: US 2015/0006157 A1
(43) Pub. Date: Jan. 1, 2015

(54) TERM SYNONYM ACQUISITION METHOD AND TERM SYNONYM ACQUISITION APPARATUS

(71) Applicants: Daniel Georg Andrade Silva, Tokyo (JP); Kai Ishikawa, Tokyo (JP); Masaaki Tsuchida, Tokyo (JP); Takashi Onishi, Tokyo (JP)

(72) Inventors: Daniel Georg Andrade Silva, Tokyo (JP); Kai Ishikawa, Tokyo (JP); Masaaki Tsuchida, Tokyo (JP); Takashi Onishi, Tokyo (JP)

(73) Assignee: NEC Corporation, Tokyo (JP)

(21) Appl. No.: 14/376,517

(22) PCT Filed: Mar. 14, 2012
(86) PCT No.: PCT/JP2012/057247

§ 371 Date: Aug. 4, 2014

(51) Int. Cl. G06F 17/27

(52) U.S. Cl. CPC G06F 17/2795; G06F 17/275
USPC 704/9

(57) ABSTRACT

A term synonym acquisition apparatus includes: a first generating unit which generates a context vector of an input term in an original language and a context vector of each synonym candidate in the original language; a second generating unit which generates a context vector of an auxiliary term in an auxiliary language that is different from the original language, where the auxiliary term specifies a sense of the input term; a combining unit which generates a combined context vector based on the context vector of the input term and the context vector of the auxiliary term; and a ranking unit which compares the combined context vector with the context vector of each synonym candidate to generate ranked synonym candidates in the original language.

### TECHNICAL FIELD

The present invention relates to a term synonym acquisition method and a term synonym acquisition apparatus. In particular, the present invention relates to a technique which can improve the automatic acquisition of new synonyms.

### BACKGROUND ART

Automatic synonym acquisition is an important task for various applications. It is used for example in information retrieval to expand queries appropriately. Another important application is textual entailment, where synonyms and terms related in meaning need to be related (lexical entailment). Lexical entailment is known to be crucial to judge textual entailment. A term refers here to a single word, a compound noun, or a multiple word phrase.

Previous research which is summarized in Non-Patent Document 1 uses the idea that terms which occur in similar context, i.e. distributional similar terms, are also semantically similar. In Non-Patent Document 1, first, a large monolingual corpus is used to extract context vectors for the input term and all possible synonym candidates. Then, the similarity between the input term's context vector and each synonym candidate's context vector is calculated. Finally, using these similarity scores the candidates are output in a ranking, where the most similar candidates are ranked first. However, the input term might be ambiguous or might occur only infrequently in the corpus, which decreases the chance of finding the correct synonym.

One problem of the method related to previous work like Non-Patent Document 1 is that the input term might be ambiguous. For example the input might be [symbol] [barubu] (“bulb” or “valve”), where it is not clear whether the desired synonym is [symbol] [denkyū](“bulb”) or [symbol] [ben] (“valve”). Herein, a word enclosed by [ ] is a romanized spelling of a Japanese word that is placed immediately before that word. For example, the phrase “ [symbol] C[barubu]” means that the word “barubu” is a romanized spelling of the Japanese word “ [symbol] ”. These two meanings are conflated into one context vector (in the notation of Non-Patent Document 1, each dimension in a context vector is referred to as a word with certain features), which makes it difficult to find either synonym. Another problem is that the user's input term might occur in the corpus only a few times (low-frequency problem), and therefore it is difficult to reliably create a context vector for the input term.

Non-Patent Document 1: “Co-occurrence retrieval: A flexible framework for lexical distributional similarity”, J. Weeds and D. Weir, Computational Linguistics 2005

Previous solutions allow the user to input only one term for which the system tries to find a synonym. However, the context vector of one term does in general not reliably express one meaning, and therefore can result in poor accuracy.

This is true, in particular, if the input term is ambiguous. An ambiguous term's context vector, which contains correlation information related to different senses, leads to correlation information which can be difficult to compare across languages. The user might for example input the ambiguous word [symbol] [barubu](“bulb” or “valve”). The resulting context vector will be noisy, since it contains the context information of both meanings, “bulb” and “valve”, which will lead to a lower chance of finding the appropriate synonym. This problem is not addressed by works summarized in Non-Patent Document 1, and is illustrated in FIG. 5. FIG. 5 shows the context vector of the word [symbol] [barubu](“bulb” or “valve”) and the context vectors of synonym candidates [symbol] [enjin] (“engine”). [symbol] [denkyū] (“bulb”), and [symbol] [ben] (“valve”). The former context vector is compared to each of the latter context vectors. The incorrect synonym [symbol] [enjin] (“engine”) ranks first, since [symbol] [enjin] (“engine”) as well as [symbol] [barubu](“bulb” or “valve”) are highly correlated with the words [symbol] [hikari](“light”), [symbol] [tentō] (“switch on”), [symbol] [paipu] (“pipe”), and [symbol] [symbol] [akeru] (“open”). However, [symbol] [barubu] (“bulb” or “valve”) is only highly correlated with the words [symbol] [paipu] (“pipe”) and [symbol] [akeru] (“open”) when it is used in the sense of “valve” (see also FIG. 7). This in turn leads to a low similarity with the context vector of [symbol] [denkyū] (“bulb”). Similarly. [symbol] [barubu] (“bulb” or “valve”) is only highly correlated with the words [symbol] [hikari] (“light”) and [symbol] [tentō](“switch on”) when it is used in the sense of “bulb” (see also FIG. 7). This leads to a low similarity with the context vector of [symbol] [ben] (“valve”).

The present invention addresses the problem of finding an appropriate synonym for an ambiguous input term which context vector is unreliable.

### DISCLOSURE OF INVENTION

An exemplary object of the present invention is to provide a term synonym acquisition method and a term synonym acquisition apparatus that solve the aforementioned problems.

An exemplary aspect of the present invention is a term synonym acquisition apparatus which includes: a first generating unit which generates a context vector of an input term in an original language and a context vector of each synonym candidate in the original language; a second generating unit which generates a context vector of an auxiliary term in an auxiliary language that is different from the original language, where the auxiliary term specifies a sense of the input term; a combining unit which generates a combined context vector based on the context vector of the input term and the context vector of the auxiliary term; and a ranking unit which compares the combined context vector with the context vector of each synonym candidate to generate ranked synonym candidates in the original language.

Another exemplary aspect of the present invention is a term synonym acquisition method which includes: generating a context vector of an input term in an original language and a context vector of each synonym candidate in the original language; generating a context vector of an auxiliary term in an auxiliary language that is different from the original language, where the auxiliary term specifies a sense of the input term; generating a combined context vector based on the context vector of the input term and the context vector of the auxiliary term; and comparing the combined context vector with the context vector of each synonym candidate to generate ranked synonym candidates in the original language.

Yet another exemplary aspect of the present invention is a computer-readable recording medium which stores a program that causes a computer to execute: a first generating function of generating a context vector of an input term in an original language and a context vector of each synonym candidate in the original language; a second generating function of generating a context vector of an auxiliary term in an auxiliary language that is different from the original language, where the auxiliary term specifies a sense of the input term; a combining function of generating a combined context vector based on the context vector of the input term and the context vector of the auxiliary term; and a ranking function of comparing the combined context vector with the context vector of each synonym candidate to generate ranked synonym candidates in the original language.

The present invention uses additionally to the input term's context vector, auxiliary terms' context vectors in one (or more) different languages, and combines these context vectors to one context vector which reduces the impact of the input term's context vector's noise caused by the ambiguity of the input term.

The present invention can overcome the context vector's unreliability by allowing the user to input auxiliary terms in different languages which narrow down the meaning of the input term that is intended by the user. This is motivated by the fact that it is often possible to specify additional terms in other languages especially in English, with which the user is familiar. For example, the user might input the ambiguous word [symbol] [barubu] (“bulb”, “valve”) and the English translation “bulb”, to narrow down the meaning of [symbol] [barubu] (“bulb”, “valve”) to the sense of “bulb”.

As a consequence, the present invention leads to improved accuracy for synonym acquisition.

### BRIEF DESCRIPTION OF DRAWINGS

FIG. 1 is a block diagram showing the functional structure of a term synonym acquisition apparatus (a term synonym acquisition system) according to a first exemplary embodiment of the present invention.

FIG. 2 is a block diagram showing the functional structure of creation unit 40 shown in FIG. 1.

FIG. 3 is a block diagram showing the functional structure of a term synonym acquisition apparatus (a term synonym acquisition system) according to a second exemplary embodiment of the present invention.

FIG. 4 is a block diagram showing the functional structure of a term synonym acquisition apparatus (a term synonym acquisition system) according to a third exemplary embodiment of the present invention.

FIG. 5 is an explanatory diagram showing the processing of the query term [symbol] [symbol] [barubu] (“bulb”, “valve”) by previous work which uses only one input term in one language.

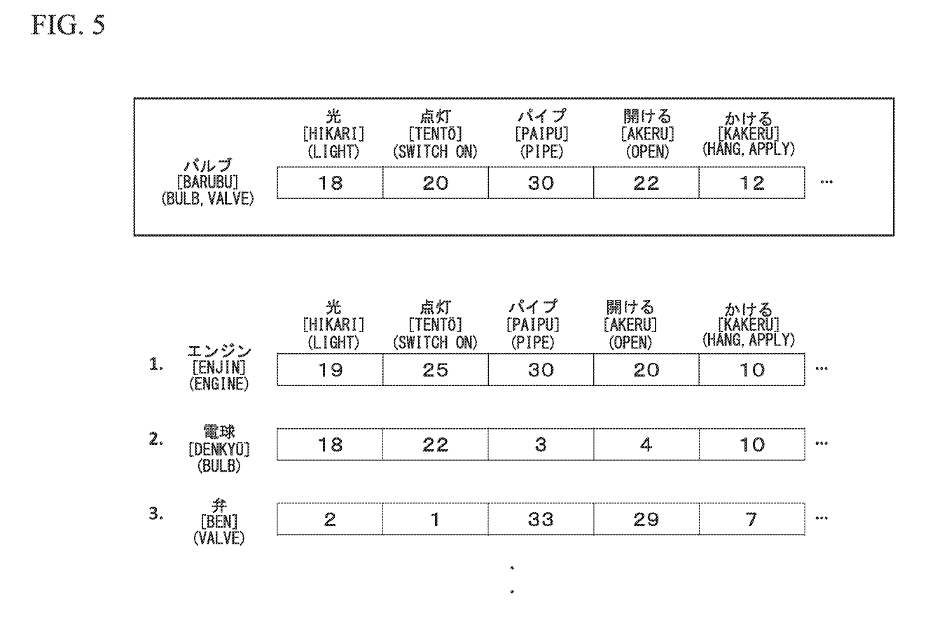

FIG. 6 is an explanatory diagram showing the extraction of the context vectors for the query term [symbol] [barubu] (“bulb”, “valve”) and the auxiliary translation “bulb” according to the exemplary embodiments of the present invention.

FIG. 7 is an explanatory diagram showing the differences of the context vectors extracted for the query term [symbol] [barubu] (“bulb”, “valve”) and the auxiliary translation “bulb”.

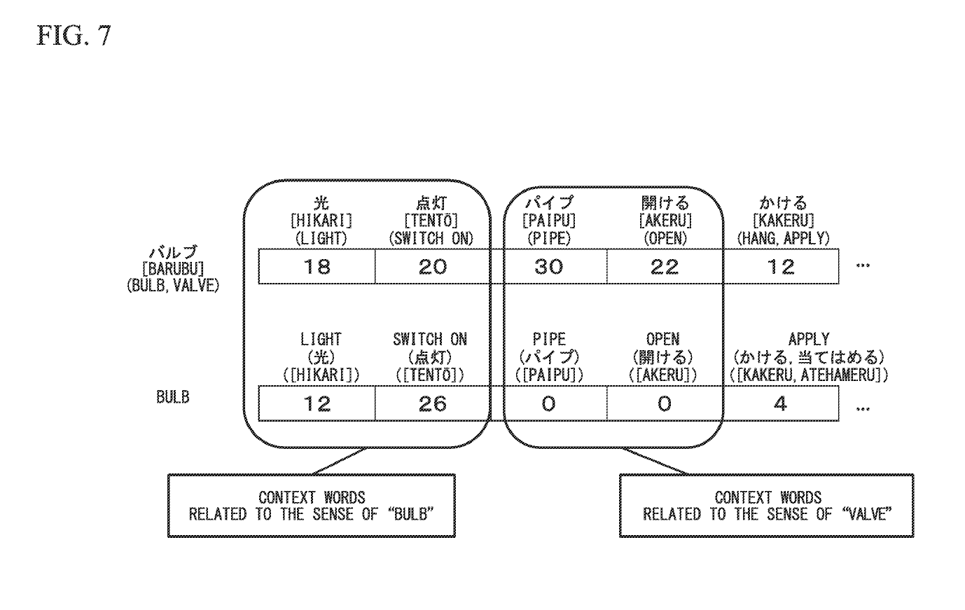

FIG. 8 is an explanatory diagram showing the processing of the query term [symbol] [symbol] [barubu] (“bulb”, “valve”) and the auxiliary translation “bulb” according to the exemplary embodiments of the present invention.

### BEST MODES FOR CARRYING OUT THE INVENTION

### First Exemplary Embodiment

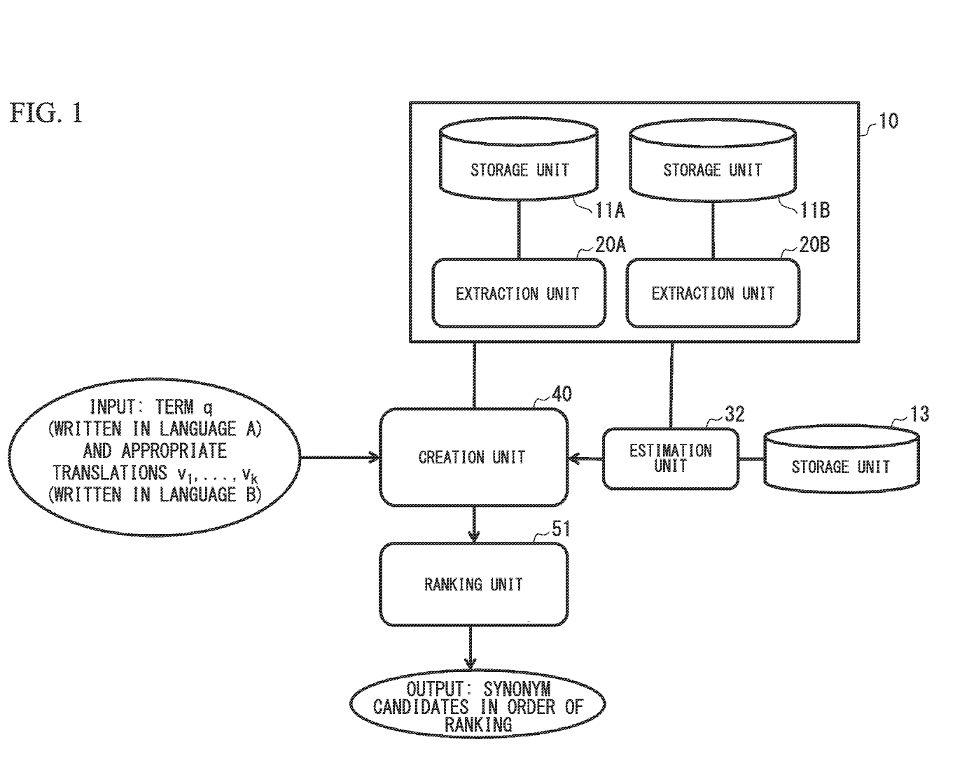

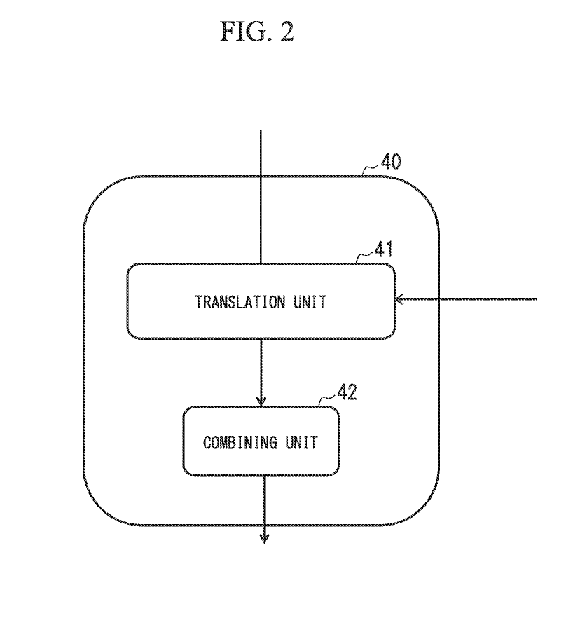

A first exemplary embodiment of the present invention will be described hereinafter by referring to FIG. 1 and FIG. 2.

FIG. 1 is a block diagram showing the functional structure of a term synonym acquisition apparatus (a term synonym acquisition system) according to the first exemplary embodiment. The term synonym acquisition apparatus includes component 10, storage unit 13, estimation unit 32, creation unit 40, and ranking unit 51. Component 10 includes storage units 11A and 11B and extraction units 20A and 20B. FIG. 2 is a block diagram showing the functional structure of creation unit 40 shown in FIG. 1. Creation unit 40 includes translation unit 41 and combining unit 42.

The first exemplary embodiment and the second and third exemplary embodiments described later also use the idea that terms which occur in similar context, i.e. distributional similar terms, are also semantically similar.

The apparatus uses two corpora stored in storage units 11A and 11B, respectively, as shown in FIG. 1. The two corpora can be two text collections written in different languages, but which contain similar topics. Such corpora are known as comparable corpora. Herein, it is assumed that the corpora stored in storage units 11A and 11B are text collections in language A (an original language) and language B (an auxiliary language), respectively, and languages A and B are Japanese and English, respectively. However, languages A and B are not limited to these languages. From these corpora, extraction unit 20A extracts context vectors for all relevant terms in language A, and extraction unit 20B extracts context vectors for all relevant terms in language B. Extraction unit 20A creates context vectors for all terms which occur in the corpus stored in 11A, where each dimension of these context vectors contains the correlation to another word in language A. Similar, extraction unit 20B does the same for all terms in English which occur in the corpus stored in storage unit 11B.

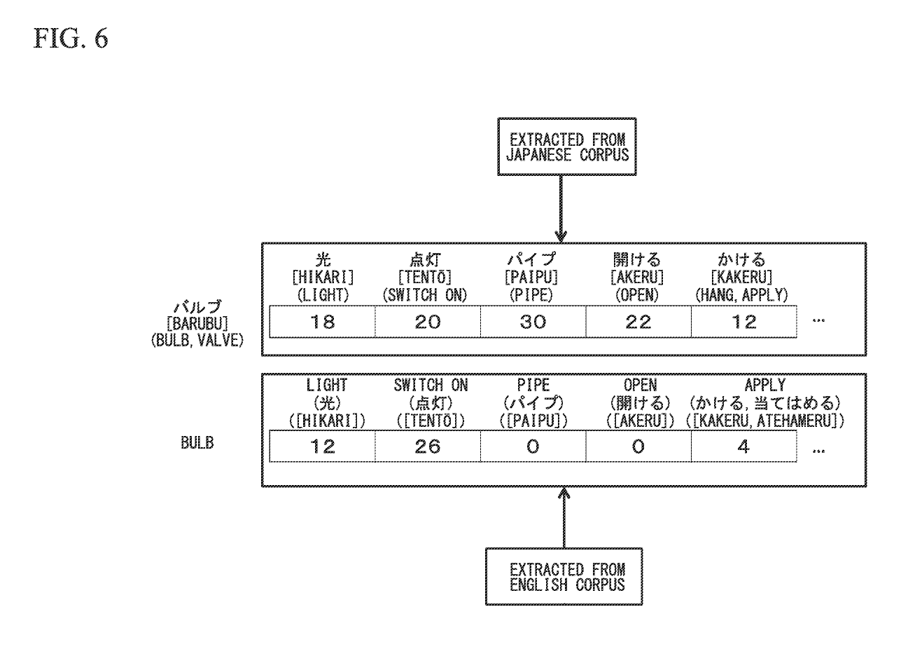

The user tries to find a synonym for a query term q in language A. Since the term q might occur only infrequently in the corpus stored in storage unit 11A, or the term q itself might be ambiguous, the user additionally specifies a set of appropriate translations (auxiliary terms) in language B. These translations are named as v₁, . . . , vₖ (k is a natural number). The set of all the translations specifies a sense of the input term. For example, the user inputs the ambiguous word [symbol] [barubu] (“bulb”, “valve”) and the English translation “bulb”. The input word and translation are supplied to creation unit 40. The context vectors extracted for these two words by extraction units 20A and 20B are shown in FIG. 6.

Creation unit 40 creates a new context vector q* which is a combination of q's context vector and v₁, . . . , vₖ's context vectors. For example, creation unit 40 combines the context vectors of [symbol] [barubu] (“bulb”, “valve”) and “bulb” into a new context vector q*. The new context vector q* is expected to focus on the sense of the word “bulb”, rather than the sense of the word “valve”. Finally, ranking unit 51 compares the context vector q* to the context vectors of all synonym candidates in language A. For example, ranking unit 51 might consider all Japanese nouns as possible synonym candidates, and then rank these candidates by comparing a candidate's context vector with the context vector q*. For comparing two context vectors ranking unit 51 can use, for example, the cosine similarity. Ranking unit 51 ranks synonym candidates in language A which are closest to the context vector q*, and outputs the synonym candidates in order of ranking.

In the following, estimation unit 32 and creation unit 40 will be described in more detail.

Hereinafter, q is denoted as the context vector of the term q in language A. A context vector q contains in each dimension the correlation between the term q and another word in language A which occurs in the corpus stored in storage unit 11A. Therefore the length of context vector q equals the number of words in the corpus stored in storage unit 11A. The first exemplary embodiment will use the notation q(x) to mean the correlation value between the term q and the word x which is calculated based on the co-occurrence of the term q and the word x in the corpus stored in storage unit 11A.

Hereinafter, v₁, . . . , vₖ are denoted as the context vectors of the terms v₁, . . . , vₖ in language B. A context vector vᵢ, 1≦i≦k, contains in each dimension the correlation between the term vᵢ and a word in language B that occurs in the corpus stored in storage unit 11B and that is also listed in a bilingual dictionary stored in storage unit 13.

Estimation unit 32 estimates the translation probabilities for the words in language B to the words in language A using the bilingual dictionary stored in storage unit 13. Estimation unit 32 only estimates the translation probabilities for the words which are listed in the bilingual dictionary stored in storage unit 13. The translation probabilities can be estimated by consulting the comparable corpora (i.e. the corpora stored in storage units 11A and 11B). This can be achieved, for example, by building a language model for each language using the comparable corpora, and then estimating the translation probabilities using expectation maximization (EM) algorithm like in Non-Patent Document 2, which is herein incorporated in its entirety by reference. This way estimation unit 32 gets the probability that word y in language B has the translation x in language A, which is denoted as p(x|y). These translation probabilities are written in a matrix T as follows:

$$T := [ \begin{matrix}p ( {x}_{1} \vert {y}_{1} ) & p ( {x}_{1} \vert {y}_{2} ) & … & p ( {x}_{1} \vert {y}_{n} ) \\ p ( {x}_{2} \vert {y}_{1} ) & p ( {x}_{2} \vert {y}_{2} ) & … & p ( {x}_{2} \vert {y}_{n} ) \\ ⋮ & ⋮ & ⋱ & ⋮ \\ p ( {x}_{m} \vert {y}_{1} ) & p ( {x}_{m} \vert {y}_{2} ) & … & p ( {x}_{m} \vert {y}_{n} )\end{matrix} ] \qquad ( 1 )$$

where m is the total number of words in language A which occur in the corpus stored in storage unit 11A and are listed in the bilingual dictionary stored in storage unit 13; analogously, n is the total number of words in language B occurring in the corpus stored in storage unit 11B and are listed in the bilingual dictionary stored in storage unit 13.

Non-Patent Document 2: “Estimating Word Translation Probabilities from Unrelated Monolingual Corpora Using the EM Algorithm”, Philipp Koehn and Kevin Knight, AAAI, 2000.

In the following, creation unit 40 will be explained, which takes the input term q, its translations v₁, . . . , vₖ, and the translation matrix T, to create a context vector q*.

First, translation unit 41 (FIG. 2) translates the context vectors v₁, . . . , vₖ into corresponding context vectors v′₁, . . . , v′ₖ in language A, respectively. Recall that a context vector vᵢ, 1≦i≦k, contains the correlations between the word vᵢ and words in language B. In order to translate a vector vᵢ into a vector which contains the correlations to words in language A, translation unit 41 uses the translation matrix T which was calculated in estimation unit 32. This new vector is denoted as v′ᵢ, and it is calculated in translation unit 41 as follows:

v′ᵢ=T·vᵢ (2)

This way translation unit 41 gets the translated context vectors v′₁, . . . , v′ₖ.

Finally, combining unit 42 combines the context vectors v′₁, . . . , v′ₖ and the context vector q to create a new context vector q*. Note that the dimension of a vector v′ᵢ and the vector q is in general different: the vector q contains the correlation to each word in the corpus stored in storage unit 11A, whereas the vector v′ᵢ contains only the correlation to each word in the corpus stored in storage unit 11A that is also listed in the bilingual dictionary stored in storage unit 13.

First, the calculations if k=1 will be explained. Let xεD, mean that the word x has at least one or more translations in dictionary D that occur in the corpus stored in storage unit 11B. The set of these translations is denoted as t(x). The context vector q* is then calculated as follows:

$${q}^{*} ( x ) := \{ \begin{matrix}q ( x ) + ( 1 - {c}_{x} ) \cdot q ( x ) + {c}_{x} \cdot {v}_{1}^{′} ( x ) , & if x ∈ D , \\ 2 \cdot q ( x ) & else\end{matrix} . \qquad ( 3 )$$

where cₓε[0, 1] is the degree of correspondence between the word x and its translations t(x). The intuition of the above equation is that, if there is a one-to-one correspondence between x and t(x), then cₓ will be set to 1, and therefore it is considered that the context vectors v′₁ and q are equally important to describe the correlation to the word x. On the other hand, if there is a many-to-many correspondence, then cₓ will be smaller than 1, and therefore the context vector q* relies more on the context vector q to describe the correlation to the word x.

Formally cₓ is set as the probability that the word x is translated into language B and then back into the word x.

cₓ=p(•|x)^{T}·p(x|•) (4)

where p(•|x) and p(x|•) are column vectors which contain in each dimension the translation probabilities from the word x into the words of language B, and the translation probabilities from the words in language B into the word x, respectively. These translation probabilities can be estimated like before in estimation unit 32, or can be simply set to the uniform distribution over the translations that are listed in the bilingual dictionary.

Note that the vector q* is not rescaled. Depending on the vector comparison method in ranking unit 51, it might be necessary to normalize the vector q*. However, if ranking unit 51 uses the cosine similarity to compare two context vectors, the result does not change if the apparatus normalizes or rescales q* by any non-zero factor.

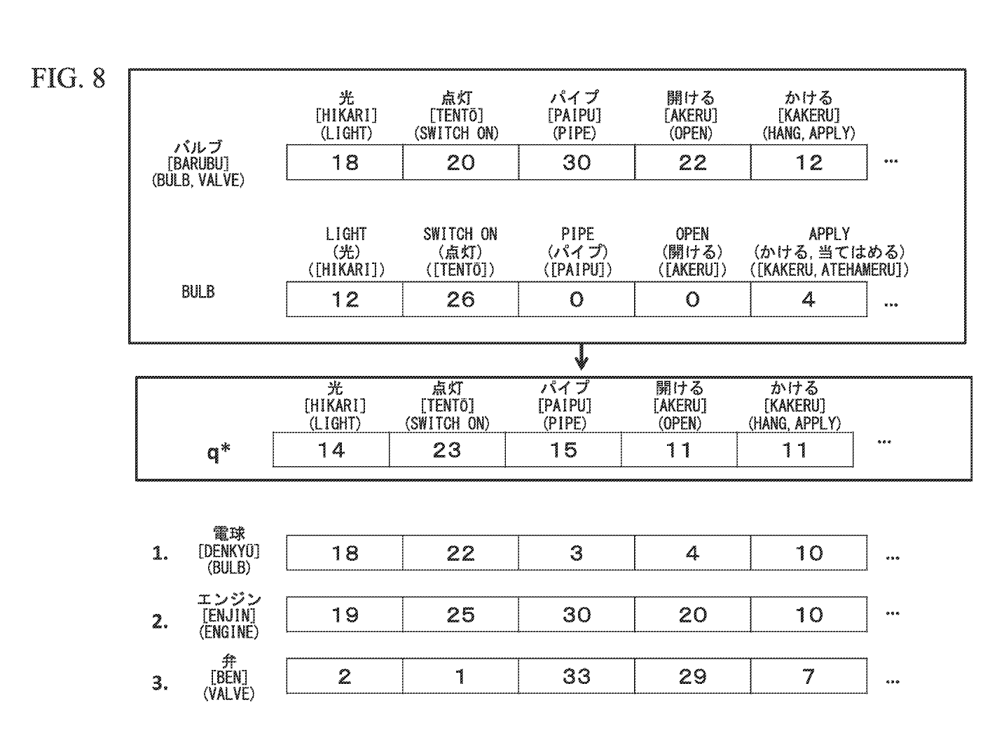

An example is shown in FIG. 8, where the context vector q, which has been created by combining the context vectors of the user's input word [symbol] [barubu] (“bulb”, “valve”) and the translation “bulb”, is compared to the context vectors of synonym candidates [symbol] [denkyū] (“bulb”), [symbol] [enjin] (“engine”), and [symbol] [ben](“valve”). As shown in FIG. 8, the combined vector is now biased towards the sense of “bulb” which leads to a higher similarity with the correct synonym [symbol] [denkyū] (“bulb”). Note that FIG. 8 shows the resulting vector q* where it is rescaled by 0.5 in order to visualize that the context vector q* is more similar to the appropriate synonym's context vector.

For the case k≧2, the calculation of q* is extended to

$${q}^{*} ( x ) := \{ \begin{matrix}q ( x ) + {\sum }_{i = 1}^{k} \{ ( 1 - {c}_{x} ) \cdot q ( x ) + {c}_{x} \cdot {v}_{1}^{′} ( x ) \} , & if x ∈ D , \\ ( k + 1 ) \cdot q ( x ) & else\end{matrix} . \qquad ( 5 )$$

This formula can be interpreted as the more auxiliary translations v₁, . . . , vₖ are given, the more the context vector q* relies on the correlation values of their translated vectors. i.e. on the values v′₁(x), . . . , v′ₖ(x). For example, if cₓ is one, the weight of q(x) is limited to

$$\frac{1}{k + 1} .$$

If cₓ<1, creation unit 40 smoothes each value v′ᵢ(x) with q(x) before combining it with q(x).

Note that the first exemplary embodiment and the second and third exemplary embodiments described later are also effective in case where the user's input term occurs only infrequently in the corpus stored in storage unit 11A, but its translation occurs frequently in the corpus stored in storage unit 11B. The problem is that a low-frequent input term's context vector is sparse and its correlation information to other words is unreliable. In that case, the proposed method can be considered as a method that cross-lingually smoothes the unreliable correlation information using the context vector of the input term's translation. This way, the problem of sparse context vectors, as well as the problem of noisy context vectors related to ambiguity can be mitigated.

Finally, note that the proposed method of the first exemplary embodiment and the second and third exemplary embodiments described later can be naturally extended to several languages. In that case, the translations of the input term, are not only in one language (language B), but in several languages (language B, language C, and so forth). Accordingly, the context vectors are extracted from comparable corpora written in languages B, and C, and so forth. Providing several bilingual dictionaries (from language A to language B, from language A to language C, and so forth) are also given, the apparatus can then proceed analogously to before in order to create a new vector q*.

### Second Exemplary Embodiment

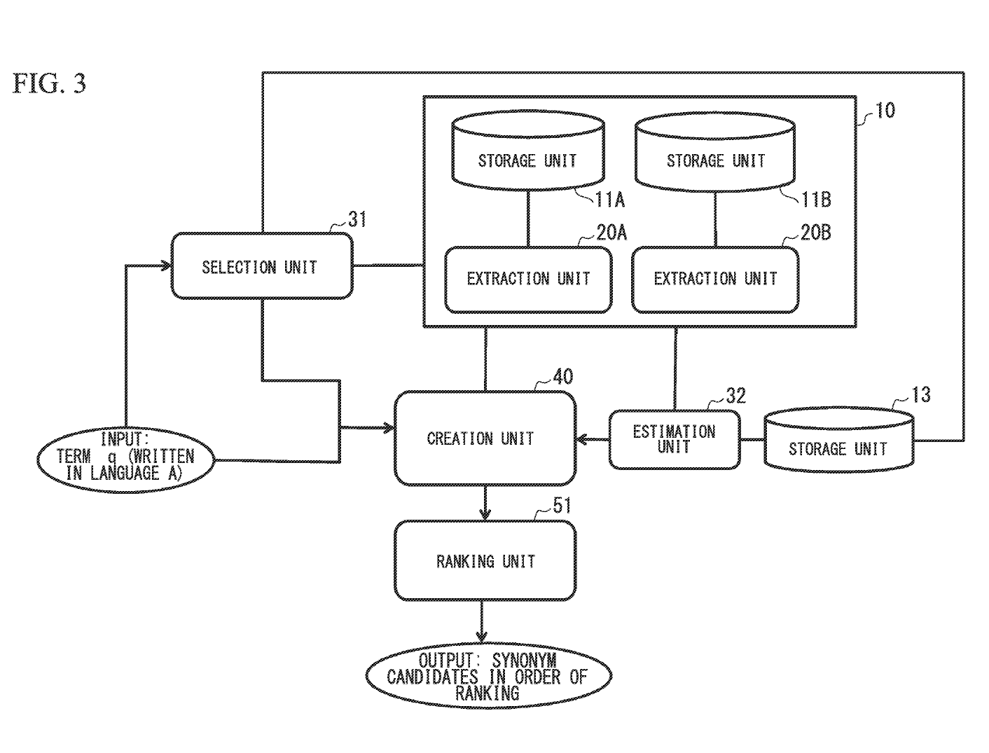

A second exemplary embodiment of the present invention will be described hereinafter by referring to FIG. 3.

FIG. 3 is a block diagram showing the functional structure of a term synonym acquisition apparatus (a term synonym acquisition system) according to the second exemplary embodiment. In FIG. 3, the same reference symbols are assigned to components similar to those shown in FIG. 1, and a detailed description thereof is omitted here. The term synonym acquisition apparatus according to the second exemplary embodiment further includes selection unit 31.

In this setting the user also inputs the term q in language A. The input term q is supplied to selection unit 31 and creation unit 40. However, the appropriate translations vᵢ, . . . , vₖ of the term q are fully-automatically selected by consulting the bilingual dictionary stored in storage unit 13 and the comparable corpora stored in storage units 11A and 11B. The selected translations are supplied to creation unit 40.

In the second exemplary embodiment, the appropriate translations v₁, . . . , vₖ written in language B are fully-automatically selected in selection unit 31. Let t(q) be the set of translations (in language 13) of the term q which are listed in the bilingual dictionary stored in storage unit 13. Then selection unit 13 can score these translations by comparing the context vector of q and the context vector of each term in t(q) using the method by Non-Patent Document 3, which is herein incorporated in its entirety by reference. Then the k-top ranking terms are assumed as the appropriate translations v₁, . . . , vₖ. This makes the assumption that the sense of the term q that is intended by the user is the dominant sense in the corpus stored in storage unit 11B. By selecting the corpus stored in storage unit 11B appropriately, the user is able to overcome low frequency and ambiguity problems in language A without specifying manually the appropriate translations.

Since the operations of the components other than selection unit 31 are the same as those of the first exemplary embodiment, a description thereof is omitted here.

Non-Patent Document 3: “A Statistical View on Bilingual Lexicon Extraction: From Parallel Corpora to Non-Parallel Corpora”, P. Fung. LNCS, 1998.

### Third Exemplary Embodiment

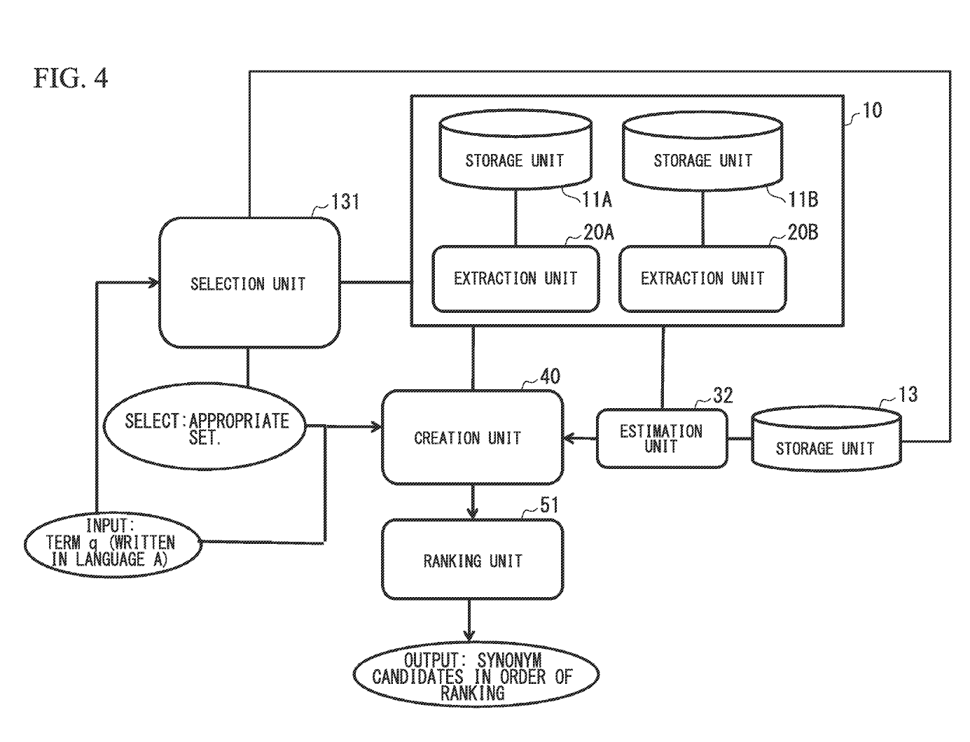

A third exemplary embodiment of the present invention will be described hereinafter by referring to FIG. 4

FIG. 4 is a block diagram showing the functional structure of a term synonym acquisition apparatus (a term synonym acquisition system) according to the third exemplary embodiment. In FIG. 4, the same reference symbols are assigned to components similar to those shown in FIG. 1, and a detailed description thereof is omitted here. The term synonym acquisition apparatus according to the third exemplary embodiment further includes selection unit 131.

In this setting the user inputs the term q in language A. The input term q is supplied to creation unit 40 and selection unit 131. However, the appropriate translations v₁, . . . , vₖ of the term q are semi-automatically selected in selection unit 131 by consulting the bilingual dictionary stored in storage unit 13 and the comparable corpora stored in storage units 11A and 11B.

In the third exemplary embodiment, the user influences the choice of the selected translations (semi-automatically), in selection unit 131. Selection unit 131 first detects automatically different senses of the input term q, by finding several sets of terms {v₁ₗ, . . . , v₁ₖ}, {v₂ₗ, . . . , v₂ₖ}, {v₃ₗ, . . . , v₃ₖ}, . . . in the auxiliary language where each set describes one sense. Depending on the desired sense of the input term q, the user selects the appropriate set from among the sets of terms {v₁ₗ, . . . , v₁ₖ}, {v₂ₗ, . . . , v₂ₖ}, {v₃ₗ, . . . , v₃ₖ}, . . . . The selected set is supplied to creation unit 40. The terms in the selected set are considered as the appropriate translations vᵢ, . . . , vₖ of the input term q. For finding several sets of terms in the auxiliary language, that describe different senses of the input term q, selection unit 131 can use a technique which matches the words correlated with q in the original language and the correlated words of q's translation in the auxiliary language with the help of the bilingual dictionary stored in storage unit 13 like in Non-Patent Document 4, which is herein incorporated in its entirety by reference. For example, for the input term [symbol] [barubu] (“bulb”. “valve”), selection unit 131 outputs the following two sets {“bulb”, “light”} and the set {“valve”, “outlet”}. The user then determines the intended sense of the word [symbol] [barubu] (“bulb”, “valve”) by selecting one of the two sets.

Since the operations of the components other than selection unit 131 are the same as those of the first exemplary embodiment, a description thereof is omitted here.

Non-Patent Document 4: “Unsupervised Word Sense Disambiguation Using Bilingual Comparable Corpora”, H. Kaji and Y. Morimoto, COLING, 2002.

While the present invention has been particularly shown and described with reference to exemplary embodiments thereof, the present invention is not limited to those exemplary embodiments. It will be understood by those of ordinary skill in the art that various changes in form and details may be made therein without departing from the spirit and scope of the present invention as defined in the claims.

For example, a program for realizing the respective processes of the exemplary embodiments described above may be recorded on a computer-readable recording medium, and the program recorded on the recording medium may be read on a computer system and executed by the computer system to perform the above-described processes related to the term synonym acquisition apparatuses.

The computer system referred to herein may include an operating system (OS) and hardware such as peripheral devices. In addition, the computer system may include a homepage providing environment (or displaying environment) when a World Wide Web (WWW) system is used.

The computer-readable recording medium refers to a storage device, including a flexible disk, a magneto-optical disk, a read only memory (ROM), a writable nonvolatile memory such as a flash memory, a portable medium such as a compact disk (CD)-ROM, and a hard disk embedded in the computer system. Furthermore, the computer-readable recording medium may include a medium that holds a program for a constant period of time, like a volatile memory (e.g., dynamic random access memory; DRAM) inside a computer system serving as a server or a client when the program is transmitted via a network such as the Internet or a communication line such as a telephone line.

The foregoing program may be transmitted from a computer system which stores this program to another computer system via a transmission medium or by a transmission wave in a transmission medium. Here, the transmission medium refers to a medium having a function of transmitting information, such as a network (communication network) like the Internet or a communication circuit (communication line) like a telephone line. Moreover, the foregoing program may be a program for realizing some of the above-described processes. Furthermore, the foregoing program may be a program, i.e. a so-called differential file (differential program), capable of realizing the above-described processes through a combination with a program previously recorded in a computer system.

### INDUSTRIAL APPLICABILITY

The present invention assists the synonym acquisition of a query term by allowing the user to describe the term by a set of related translations. In particular, it allows the user to select terms in another language which specify the intended meaning of the query term. This can help to overcome problems of ambiguity and low-frequency in the original language.

Alternatively, the appropriate translations can be automatically added by consulting a domain specific bilingual dictionary, or a general bilingual dictionary. In case of a general bilingual dictionary, appropriate translations are selected by comparing the query term's context vector with each translation's context vector.

The present invention is particularly suited in situations where it is relatively easy to specify a set of correct translations, for example in English, with the help of a bilingual dictionary, but not possible to find an appropriate synonym in an existing thesaurus.

Another application is the situation where the input term, for example in Japanese, occurs only infrequently in a small-sized Japanese corpus, however its translation occurs frequently in a large-sized English corpus. In that case, additionally to the problem of a Japanese input term's ambiguity, also the problem related to its sparse context vector can be mitigated.

1. A term synonym acquisition apparatus comprising:
a first generating unit which generates a context vector of an input term in an original language and a context vector of each synonym candidate in the original language;
a second generating unit which generates a context vector of an auxiliary term in an auxiliary language that is different from the original language, where the auxiliary term specifies a sense of the input term;
a combining unit which generates a combined context vector based on the context vector of the input term and the context vector of the auxiliary term; and
a ranking unit which compares the combined context vector with the context vector of each synonym candidate to generate ranked synonym candidates in the original language.

2. The apparatus according to claim 1, wherein the combining unit translates the context vector of the auxiliary term in the auxiliary language to a context vector in the original language, and combines the context vector of the input term and the translated context vector in the original language into the combined context vector.

3. The apparatus according to claim 2, wherein the combining unit combines the context vectors in the original language using degree of correspondence between a word in the original language and a word in the auxiliary language.

4. The apparatus according to claim 3, wherein the degree of correspondence is a probability of translating the word in the original language into the word in the auxiliary language and back to the word in the original language.

5. The apparatus according to claim 2, further comprising an estimation unit which estimates a translation probability for a word in the auxiliary language to a word in the original language,
wherein the combining unit uses the estimated translation probability to translate the context vector of the auxiliary term in the auxiliary language to the context vector in the original language.

6. The apparatus according to claim 1, further comprising a selection unit which compares the context vector of the input term with each of context vectors of translations of the input term to select the auxiliary term out of the translations of the input term.

7. The apparatus according to claim 1, further comprising a selection unit which generates a plurality of sets of terms in the auxiliary language, where the sets represent different senses of the input term, and selects a set specified by a user out of the sets of terms, as the auxiliary term.

8. The apparatus according to claim 1, wherein the combining unit generates the combined context vector so that the combined context vector is biased towards the sense specified by the auxiliary term.

9. A term synonym acquisition method comprising:
generating a context vector of an input term in an original language and a context vector of each synonym candidate in the original language;
generating a context vector of an auxiliary term in an auxiliary language that is different from the original language, where the auxiliary term specifies a sense of the input term;
generating a combined context vector based on the context vector of the input term and the context vector of the auxiliary term; and
comparing the combined context vector with the context vector of each synonym candidate to generate ranked synonym candidates in the original language.

10. A computer-readable recording medium storing a program that causes a computer to execute:
a first generating function of generating a context vector of an input term in an original language and a context vector of each synonym candidate in the original language;
a second generating function of generating a context vector of an auxiliary term in an auxiliary language that is different from the original language, where the auxiliary term specifies a sense of the input term;
a combining function of generating a combined context vector based on the context vector of the input term and the context vector of the auxiliary term; and
a ranking function of comparing the combined context vector with the context vector of each synonym candidate to generate ranked synonym candidates in the original language.

11. The apparatus according to claim 3, further comprising an estimation unit which estimates a translation probability for a word in the auxiliary language to a word in the original language,
wherein the combining unit uses the estimated translation probability to translate the context vector of the auxiliary term in the auxiliary language to the context vector in the original language.

12. The apparatus according to claim 4, further comprising an estimation unit which estimates a translation probability for a word in the auxiliary language to a word in the original language,
wherein the combining unit uses the estimated translation probability to translate the context vector of the auxiliary term in the auxiliary language to the context vector in the original language.

13. The apparatus according to claim 2, further comprising a selection unit which compares the context vector of the input term with each of context vectors of translations of the input term to select the auxiliary term out of the translations of the input term.

14. The apparatus according to claim 3, further comprising a selection unit which compares the context vector of the input term with each of context vectors of translations of the input term to select the auxiliary term out of the translations of the input term.

15. The apparatus according to claim 4, further comprising a selection unit which compares the context vector of the input term with each of context vectors of translations of the input term to select the auxiliary term out of the translations of the input term.

16. The apparatus according to claim 2, further comprising a selection unit which generates a plurality of sets of terms in the auxiliary language, where the sets represent different senses of the input term, and selects a set specified by a user out of the sets of terms, as the auxiliary term.

17. The apparatus according to claim 3, further comprising a selection unit which generates a plurality of sets of terms in the auxiliary language, where the sets represent different senses of the input term, and selects a set specified by a user out of the sets of terms, as the auxiliary term.

18. The apparatus according to claim 4, further comprising a selection unit which generates a plurality of sets of terms in the auxiliary language, where the sets represent different senses of the input term, and selects a set specified by a user out of the sets of terms, as the auxiliary term.

19. The apparatus according to claim 2, wherein the combining unit generates the combined context vector so that the combined context vector is biased towards the sense specified by the auxiliary term.

20. The apparatus according to claim 3, wherein the combining unit generates the combined context vector so that the combined context vector is biased towards the sense specified by the auxiliary term.
